(19) United States
(12) Patent Application Publication
(10) Pub. No.: US 2021/0404330 A1
(43) Pub. Date: Dec. 30, 2021

(54) MUD GAS LOG TRANSFORMATION

(71) Applicant: Saudi Arabian Oil Company, Dhahran (SA)

(72) Inventors: Vladislav Torlov, Dhahran (SA); Clovis Satyro Bonavides, Dhahran (SA)

(73) Assignee: Saudi Arabian Oil Company, Dhahran (SA)

(21) Appl. No.: 16/913,508

(22) Filed: Jun. 26, 2020

(51) Int. Cl. E21B 49/00; G01V 99/00; G06K 9/62

(52) U.S. Cl. CPC E21B 49/005; G01V 99/005; G06K 9/6215; G06K 9/6202; G06K 9/6296

(57) ABSTRACT

Disclosed are methods, systems, and computer-readable medium to perform operations including: receiving a mud gas log and a reference log of a subterranean formation; comparing a shape of a graph of the mud gas log to a shape of a graph of the reference log to determine an extent of similarity between the shape of the mud gas log graph and the shape of the reference log graph; and in response to determining that the mud gas log graph and the reference log graph have a threshold extent of similarity, transforming the mud gas log graph to track the shape of the reference log graph, wherein the transformation is performed while maintaining a total gas sum of the mud gas log.

### TECHNICAL FIELD

This disclosure relates to methods and systems for processing drilling data during a drilling operation and performing operations based on the processed data.

### BACKGROUND

In wellbore drilling, a drilling system causes a drill bit to rotate when in contact with a subterranean formation. The rotation of the drill bit breaks and fractures the formation to form the wellbore. While drilling the wellbore, the drilling system circulates a drilling fluid (also referred to as “drilling mud” or “mud”) to the drill bit, where the drilling fluid exits through drill bit nozzles to the bottom of the wellbore. The drilling fluid serves many purposes including, but not limited to, cooling the drill bit, supplying hydrostatic pressure upon the formation to prevent fluids from flowing into the wellbore, and carrying formation cuttings from the wellbore to the surface.

### SUMMARY

At the surface, the drilling fluid can be analyzed in order to extract information indicative of the drilled formation. As an example, the formation cuttings may be analyzed to extract information indicative of the layers of the drilled formation. As another example, hydrocarbon gas detectors may record a level of natural gas found in the drilling fluid. The mud gas data is used to generate a mud gas log, which includes qualitative and quantitative data from the hydrocarbon gas detectors.

In theory, mud gas levels of the mud gas log can be used to derive an amount of hydrocarbons in the subterranean formation. However, in practice, environmental conditions affect the accuracy of measured gas levels and a calculated tying depth of a source of mud gas peaks. These environmental conditions include thickness of hydrocarbon-bearing beds, well depth, drilling parameters, hydrocarbon composition, formation properties (for example, porosity and permeability), overbalance, and mud type.

This disclosure describes methods and systems for correcting a mud gas log in order to facilitate using the mud gas log to generate a model that can accurately derive information, such as hydrocarbon oil fractions, from mud gas logs. In an embodiment, a transformation algorithm corrects the mud gas log by reshaping a graphical representation (for example, a graph) of the mud gas log to follow a graphical representation (for example, a graph) of a reference log (for example, indicative of a hydrocarbon fraction) within a hydrocarbon-bearing layer. This transformation algorithm rectifies effects that prevent the modeling of raw mud gas data, such as depth discrepancy between mud gas data measured at the surface and the reference log, and hydrocarbon dispersion in the mud column. The transformed mud gas graph is analyzed to determine a relationship between the mud gas log and the reference log. The corrected data is then used to generate the model to determine hydrocarbon oil fractions from mud gas logs that is more representative than if raw data were used. The established model can be applied in real-time during drilling operations or at later stages.

Aspects of the subject matter described in this specification may be embodied in methods that include the actions of: receiving a mud gas log and a reference log of a subterranean formation; comparing a shape of a graph of the mud gas log to a shape of a graph of the reference log to determine an extent of similarity between the shape of the mud gas log graph and the shape of the reference log graph; and in response to determining that the mud gas log graph and the reference log graph have a threshold extent of similarity, transforming the mud gas log graph to track the shape of the reference log graph, wherein the transformation is performed while maintaining a total gas sum of the mud gas log.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In a first aspect, the method further includes defining a summation interval in the mud gas log and in the reference log; and summing the mud gas log and the reference log over the defined summation interval.

In a second aspect, the method further includes generating, based on the transformed mud gas log graph, a model of a relationship between mud gas data and hydrocarbon fractions.

In a third aspect, the mud gas log is a first mud gas log, and the method further includes receiving a second mud gas log of an interval in the subterranean formation; and determining, based on the second mud gas log and the model, a hydrocarbon fraction in the interval of the subterranean formation.

In a fourth aspect, the reference log is one of a wireline log, a logging while drilling log, or a drilling parameter log.

In a fifth aspect, transforming the mud gas log graph to track the shape of the reference log graph includes determining, based on a predetermined hydrocarbon-bearing threshold, one or more hydrocarbon-bearing zones (ZPs) within the mud gas log graph; and reshaping the one or more hydrocarbon-bearing zones based on respective shapes of one or more portions of the reference log graph that correspond to the one or more hydrocarbon-bearing zones.

In a sixth aspect, detecting, based on the hydrocarbon-bearing threshold, one or more hydrocarbon-bearing zones within the mud gas log graph includes detecting and subtracting background noise from the mud gas log graph, wherein the background noise is detected based on a predetermined noise level; despiking the mud gas log graph to remove artifacts that are not correlated to reservoir features; defining the hydrocarbon-bearing threshold as a function of the noise level; and identifying the one or more hydrocarbon-bearing zones by identifying values of the mud gas log graph that cross the hydrocarbon-bearing threshold.

In a seventh aspect, reshaping the one or more hydrocarbon-bearing zones within the mud gas log graph based on respective shapes of one or more regions of the reference log graph that correspond to the one or more hydrocarbon-bearing zones includes for each hydrocarbon-bearing zone: determining a respective top boundary (ZPₜₒₚ) and a respective bottom boundary (ZP_{bot}); determining a respective maximum reading (ZPₘₐₓ); computing a respective boundary delimiting value (BD) as a function of the respective ZPₘₐₓ and the hydrocarbon-bearing threshold; determining, based on the respective BD, a respective top boundary (Bₜₒₚ) and a respective bottom boundary (B_{bot}); and fine tuning depth matching between the Bₜₒₚ−B_{bot} interval in the mud gas log graph and a corresponding interval corrBₜₒₚ−corrB_{bot} in the reference log graph.

In an eight aspect, fine tuning depth matching between the Bₜₒₚ−B_{bot} interval in the mud gas log graph and a corresponding interval in the reference log graph includes: calculating a respective volume of hydrocarbons (Vₜₒₜ₁) is for the interval Bₜₒₚ−B_{bot}; calculating a respective volume of hydrocarbons (Vₜₒₜ₂) for the hydrocarbon-bearing zone; calculating a ratio (Rᵥₒₗ) of Vₜₒₜ₂ to Vₜₒₜ₁; multiplying by Rᵥₒₗ a portion of the mud gas log within the Bₜₒₚ−B_{bot} interval; and fine tuning depth matching the portion of the mud gas log graph and a portion of the reference log graph within the corresponding interval.

In a ninth aspect, the method further includes multiplying the fine tune depth matched portion of the mud gas log graph by a ratio of the Bₜₒₚ−B_{bot} interval to the corrBₜₒₚ−corrB_{bot} interval.

The subject matter described in this specification can be implemented to realize one or more of the following advantages. Evaluation of well surveys indicates that depth discrepancies exist between reference logs and mud gas logs that are generated using existing techniques. Such discrepancies are particularly noticeable at bed boundaries and thin beds. Due to these discrepancies, well surveys may erroneously indicate that hydrocarbon-bearing beds near the discrepancies are not productive. Existing depth correction methods cause biases in the corrected logs, and thus, are not suitable for correcting these discrepancies. The disclosed techniques resolve discrepancies between reference and mud gas logs. Thus, the disclosed techniques rectify effects that prevent modeling of raw mud gas data, such as the described depth discrepancies and hydrocarbon dispersion in the mud column.

Further, the disclosed techniques provide geoscientists (for example, petrophysicists, geologists, or mud logging specialists) with a tool to transform raw data based on comparison with reference logs. The transformations are applied to match the hydrocarbon column as detected by the more accurate reference logs. By transforming the data, the accuracy of hydrocarbon depth indexes and corresponding mud gas levels increase, which improves the usability of mud gas logs for quantitative assessments. The improved data can be used to assist in petrophysical model selection, calculation of hydrocarbon in place, and planning of future wells evaluation programs (for example, in selection of mud logging equipment, drilling parameters, logging programs). Furthermore, the models generated based on the transformed data may be used to determine hydrocarbon fractions, which in turn, may be used to control drilling operations.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### DESCRIPTION OF DRAWINGS

FIG. 1 is a schematic view of an example drilling system for a well, according to some implementations of the present disclosure.

FIG. 2 illustrates a block diagram of a processing system, according to some implementations of the present disclosure.

FIG. 3 illustrates an example method for mud gas log processing, according to some implementations of the present disclosure.

FIG. 4A illustrates an example mud gas curve, according to some implementations of the present disclosure.

FIG. 4B illustrates an example reference curve, according to some implementations of the present disclosure.

FIGS. 5A, 5B, 5C, and 5D illustrate an example implementation of mud gas log processing, according to some implementations of the present disclosure.

FIG. 6 is a flow chart of another example method for mud gas log processing, according to some implementations.

FIG. 7 illustrates a block diagram illustrating an example computer system, according to some implementations of the present disclosure.

Like reference symbols in the various drawings indicate like elements.

### DETAILED DESCRIPTION

As stated above, environmental conditions affect the accuracy of measured gas levels, and therefore, in practice, raw mud gas logs oftentimes cannot be used to accurately determine hydrocarbon fractions. This disclosure describes methods and systems for transforming a mud gas log to facilitate using the mud gas log to generate a model that can accurately derive information, such as hydrocarbon oil fractions, from mud gas logs. In an embodiment, a transformation algorithm is used to transform raw mud gas data based on a comparison with reference logs (for example, wireline (WL) or logging while drilling (LWD) surveys). More specifically, the transformation algorithm corrects a mud gas log by reshaping a graphical representation (for example, a graph or curve) of the mud gas log to follow a graphical representation of a reference log within a hydrocarbon-bearing layer. The transformation algorithm enables selection of background gas levels and correction for a hydrocarbon tail effect.

The output of the transformation algorithm is used in at least one of two statistical analyses. A first analysis is a level-by-level comparison of the transformed mud gas log to the reference log. This analysis can be used to correct the input log and can reshape a graphical representation of the input log to follow the profile of the reference logs. A second analysis is a summation, where normalized hydrocarbon gas is summed across a selected interval (for example, a thin formation layer or a total reservoir thickness). In this analysis, transformation may not be necessary or may be reduced. Summation of hydrocarbon fraction in the reference log may also be performed across a corresponding depth interval in order to facilitate quantitative analysis.

In an embodiment, data points are gathered from multiple intervals, and then, statistical analysis of summation method outputs and comparison with level-by-level data is performed. Further, using an output level-by-level analysis graph, machine learning techniques can be used to generate models, for particular environmental conditions, that can determine a hydrocarbon fraction from mud log data. For example, the generated models can be used to determine a hydrocarbon fraction from mud log data in real-time while drilling. The term “real-time” can correspond to events that occur within a specified period, such as within one minute, within one second, or within milliseconds.

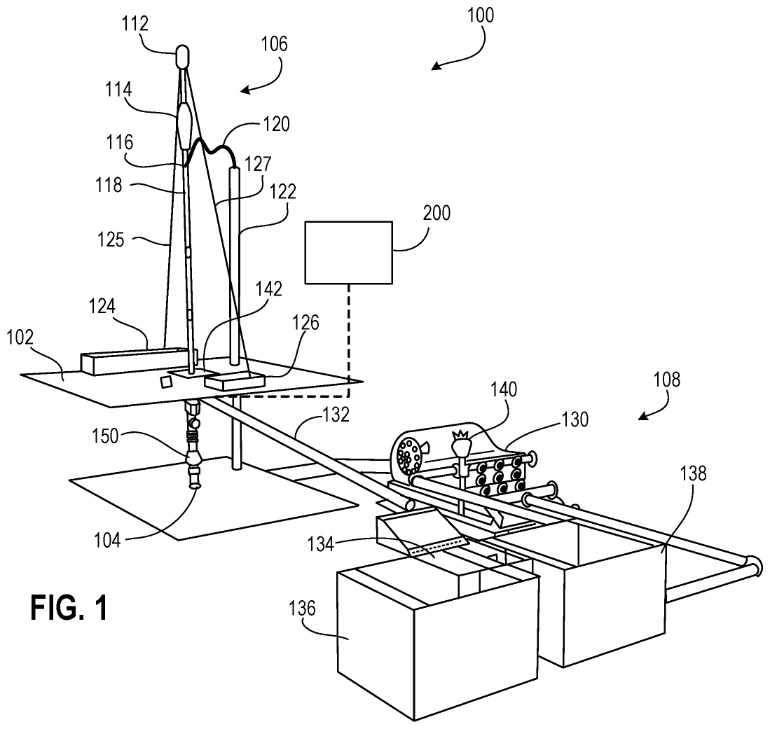

FIG. 1 is a schematic of an example drilling system 100 for drilling and producing a well, according to some implementations. The well can extend from a surface through the Earth to one or more subterranean zones of interest. The drilling system 100 includes a drill floor 102 positioned above the surface, a wellhead 104, a drill string assembly 106 supported by a rig structure, a fluid circulation system 108 to filter used drilling fluid from the wellbore and provide clean drilling fluid to the drill string assembly 106, and a processing system 200. Although the processing system 200 is illustrated in proximity of the drilling system 100, the processing system 200 may be located remotely from the drilling system 100, perhaps onsite or offsite. In an example, the drilling system 100 is shown as a drill rig capable of performing a drilling operation with a rig structure supporting the drill string assembly 106 over a wellbore. The wellhead 104 can be used to support casing or other well components or equipment into the wellbore of the well.

The derrick or mast is a support framework mounted on the drill floor 102 and positioned over the wellbore to support the components of the drill string assembly 106 during drilling operations. A crown block 112 forms a longitudinally-fixed top of the derrick, and connects to a travelling block 114 with a drilling line including a set of wire ropes or cables. The crown block 112 and the travelling block 114 support the drill string assembly 106 via a swivel 116, a kelly 118, or a top drive system (not shown). Longitudinal movement of the travelling block 114 relative to the crown block 112 of the drill string assembly 106 acts to move the drill string assembly 106 longitudinally upward and downward. The swivel 116, connected to and hung by the travelling block 114 and a rotary hook, allows free rotation of the drill string assembly 106 and provides a connection to a kelly hose 120, which is a hose that flows drilling fluid from a drilling fluid supply of the circulation system 108 to the drill string assembly 106. A standpipe 122 mounted on the drill floor 102 guides at least a portion of the kelly hose 120 to a location proximate to the drill string assembly 106. The kelly 118 is a hexagonal device suspended from the swivel 116 and connected to a longitudinal top of the drill string assembly 106, and the kelly 118 turns with the drill string assembly 106 as the rotary table 142 of the drill string assembly turns.

In the drilling system 100, the drill string assembly 106 is made up of drill pipes with a drill bit (not shown) at a longitudinally bottom end of the drill string. The drill pipe can include hollow steel piping, and the drill bit can include cutting tools, such as blades, disc, rollers, cutters, or a combination of these, to cut into the formation and form the wellbore. The drill bit rotates and penetrates through rock formations below the surface under the combined effect of axial load and rotation of the drill string assembly 106. In some implementations, the kelly 118 and swivel 116 can be replaced by a top drive that allows the drill string assembly 106 to spin and drill. The wellhead assembly 104 can also include a drawworks 124 and a deadline anchor 126, where the drawworks 124 includes a winch that acts as a hoisting system to reel the drilling line in and out to raise and lower the drill string assembly 106 by a fast line 125. The deadline anchor 126 fixes the drilling line opposite the drawworks 124 by a deadline 127, and can measure the suspended load (or hook load) on the rotary hook. The weight on bit (WOB) can be measured when the drill bit is at the bottom the wellbore. The wellhead assembly 104 also includes a blowout preventer 150 positioned at the surface 101 of the well and below (but often connected to) the drill floor 102. The blowout preventer 150 acts to prevent well blowouts caused by formation fluid entering the wellbore, displacing drilling fluid, and flowing to the surface at a pressure greater than atmospheric pressure. The blowout preventer 150 can close around (and in some instances, through) the drill string assembly 106 and seal off the space between the drill string and the wellbore wall. The blowout preventer 150 is described in more detail later.

During a drilling operation of the well, the circulation system 108 circulates drilling fluid from the wellbore to the drill string assembly 106, filters used drilling fluid from the wellbore, and provides clean drilling fluid to the drill string assembly 106. The example circulation system 108 includes a fluid pump 130 that fluidly connects to and provides drilling fluid to drill string assembly 106 via the kelly hose 120 and the standpipe 122. The circulation system 108 also includes a flow-out line 132, a shale shaker 134, a settling pit 136, and a suction pit 138. In a drilling operation, the circulation system 108 pumps drilling fluid from the surface, through the drill string assembly 106, out the drill bit and back up the annulus of the wellbore, where the annulus is the space between the drill pipe and the formation or casing. The density of the drilling fluid is intended to be greater than the formation pressures to prevent formation fluids from entering the annulus and flowing to the surface and less than the mechanical strength of the formation, as a greater density may fracture the formation, thereby creating a path for the drilling fluids to go into the formation. Apart from well control, drilling fluids can also cool the drill bit and lift rock cuttings from the drilled formation up the annulus and to the surface to be filtered out and treated before it is pumped down the drill string assembly 106 again. The drilling fluid returns in the annulus with rock cuttings and flows out to the flow-out line 132, which connects to and provides the fluid to the shale shaker 134. The flow line is an inclined pipe that directs the drilling fluid from the annulus to the shale shaker 134. The shale shaker 134 includes a mesh-like surface to separate the coarse rock cuttings from the drilling fluid, and finer rock cuttings and drilling fluid then go through the settling pit 136 to the suction pit 136. The circulation system 108 includes a mud hopper 140 into which materials (for example, to provide dispersion, rapid hydration, and uniform mixing) can be introduced to the circulation system 108. The fluid pump 130 cycles the drilling fluid up the standpipe 122 through the swivel 116 and back into the drill string assembly 106 to go back into the well.

The example wellhead assembly 104 can take a variety of forms and include a number of different components. For example, the wellhead assembly 104 can include additional or different components than the example shown in FIG. 1. Similarly, the circulation system 108 can include additional or different components than the example shown in FIG. 1.

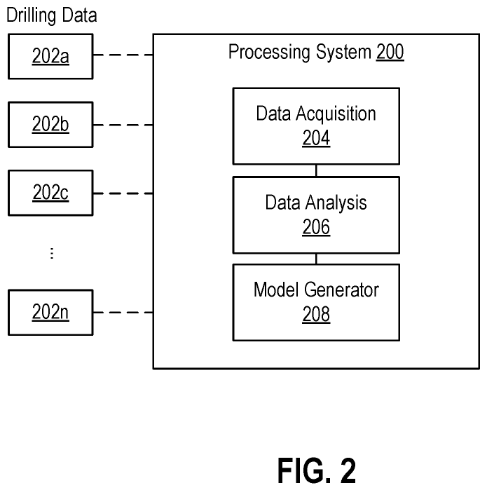

FIG. 2 illustrates a block diagram of the processing system 200, according to some implementations. In an embodiment, the processing system 200 is configured to transform a mud gas log, analyze the transformed mud gas log, and generate models based on the transformed mud gas log. Furthermore, the processing system 200 may use the generated models to derive information indicative of the subsurface. As shown in FIG. 2, the processing system 200 includes a data acquisition module 204, a data analysis module 206, and a model generator 208.

The data acquisition module 204 may be configured to acquire data from a plurality of sources. As shown in FIG. 2, the data acquisition module 204 may acquire drilling data 202a, 202b, 202c . . . 202n (collectively referred to as drilling data 202) from a plurality of sources. Each instance of the drilling data 202 may represent drilling data acquired from a different source. For example, the drilling data 202 may include values of drilling parameters (for example, rate of penetration (ROP)), measurement while drilling (MWD) data, logging while drilling (LWD) data, wireline (WL) data, mud data, or any other data related to a drilling operation. The data acquisition module 204 may also determine parameters for acquiring the drilling data. For example, the data acquisition module 204 may determine candidate formation and borehole settings that decrease a number of artifacts in the drilling data. In scenarios where the drilling data is measured by a system other than the processing system 200, the data acquisition module 204 may provide the other system with instructions indicative of the determined parameters.

The data analysis module 206 may be configured to process and analyze the acquired drilling data. In an example, the data analysis module 206 may generate logs of the acquired drilling data. In another example, the data analysis module 206 may transform drilling data, such as a mud gas log. For instance, the data analysis module 206 may use the disclosed transformation algorithm to correct a mud gas log. Furthermore, the data analysis module 206 may analyze the corrected mud gas log and may compare the corrected mud gas log to other drilling data, such as an LWD log.

Once the data analysis module 206 has transformed and analyzed the drilling data, the model generator 208 may use the transformed drilling data and the analyses to generate models of the subsurface. For example, the model generator 208 may use machine learning or artificial intelligence tools to generate, based the corrected drilling data and the analyses, a model for particular environmental conditions. The generated model can be used to determine a hydrocarbon fraction in the drilled formation.

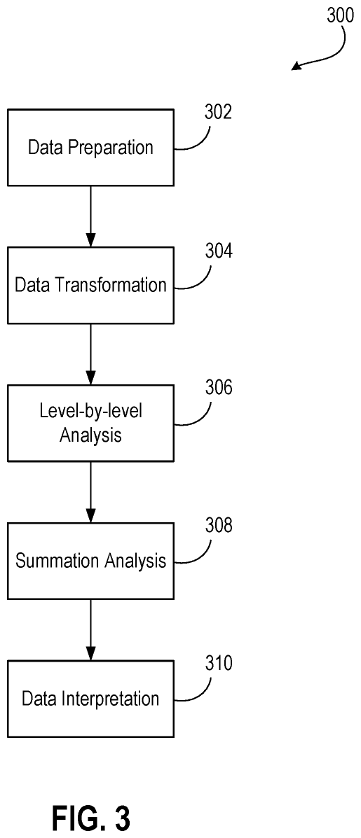

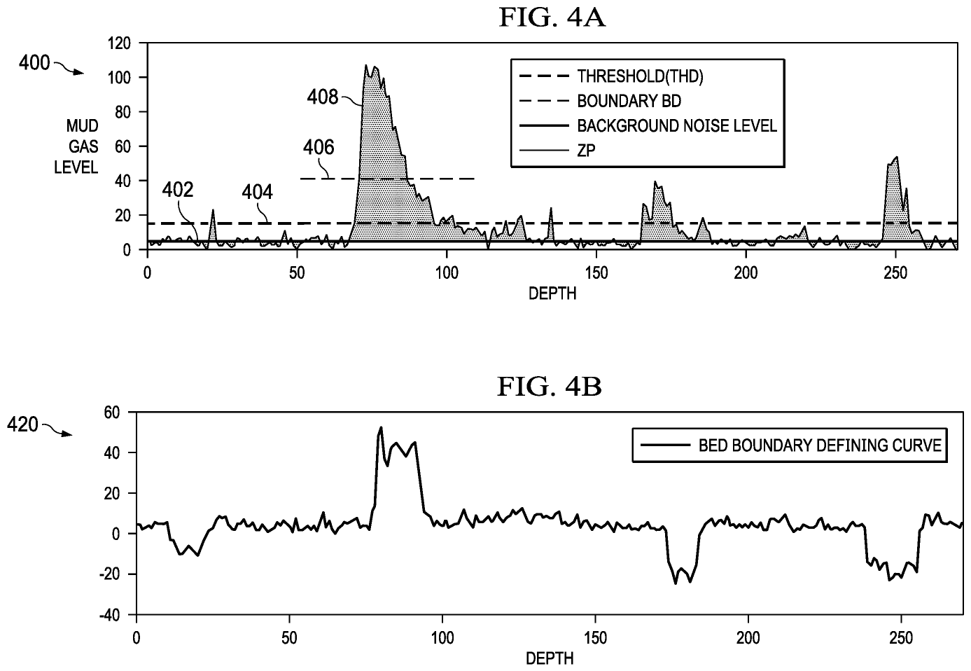

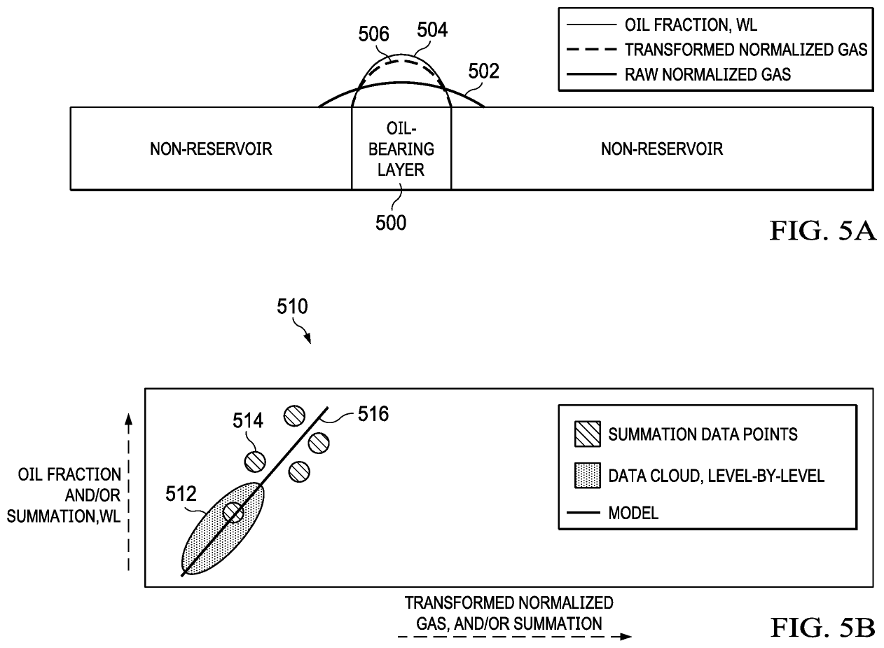

FIG. 3 illustrates an example method 300 for mud gas log processing, according to some implementations. In an embodiment, the method 300 may be performed by the processing system 200. In particular, the processing system 200 may execute the method 300 to transform a mud gas log, analyze the transformed mud gas log, and generate models based on the transformed mud gas log. Additionally, the processing system 200 may generate instructions for a drilling system, such as the drilling system 100. The processing system 200 may execute the method 300 during a drilling operation, perhaps at periodic intervals in time (minutes, hours, or days) or drilling depth (tens, hundreds, or thousands of feet). Further, the processing system 200 may execute multiple iterations of the method 300, where each iteration uses different data (for example, the reference log). In the discussion of the method 300, reference is also made to FIG. 2, FIG. 4A, and FIG. 4B.

The method 300 starts at data preparation step 302, which may be performed by the data acquisition module 204 of FIG. 2. In this step, the processing system 200 determines parameters for acquiring mud data. For example, the processing system 200 may select candidate formation and borehole settings that decrease a number of artifacts in the mud data. In scenarios where the mud data is measured by a system other than the processing system 200, the processing system 200 provides the other system with instructions indicative of the selected parameters. Once the parameters are specified, the processing system 200 acquires the mud data. In some examples, the processing system 200 may normalize the acquired data in order to account for variation in drilling parameters. Additionally, the processing system 200 may generate a mud gas log based on mud gas data.

In an example, the processing system 200 determines the candidate formation and borehole settings based on a magnitude of artifacts (for example, depth mismatches), which can be assessed from analysis of reference and mud logs profile along the borehole depth. Besides the reference hydrocarbon volume fraction, other types of depth logs (for example, gamma ray, bulk density, acoustic, and calculated porosity) can be used to identify bed boundaries, and therefore support identification of depth mismatches. Additionally, the scatter plot of a reference log versus mud gas log can also be used for this purpose.

In step 302, the processing system 200 may also acquire reference data. As described in this disclosure, the processing system 200 may use the reference data for transforming the mud log data and for analyzing the transformed mud log data. The reference data may be measurement while drilling (MWD) data, logging while drilling (LWD) data, wireline (WL) data, and drilling parameters (for example, rate of penetration (ROP)). Furthermore, the processing system may generate graphical representations (for example, graph, plot, curve, or chart) of the reference data.

In scenarios where the processing system 200 receives more than one type of drilling data, the processing system 200 may select one type of drilling data as the reference data. For instance, if the processing system 200 receives LWD data and WL data, the processing system 200 may select one of those as the reference data. In some examples, the processing system 200 may use predetermined selection criteria in order to select the reference data to use. In one example, the processing system 200 may select the reference data based on an assigned hierarchy. For instance, wireline data may be a first choice, logging while drilling data may be a second choice, and other drilling parameters may be a third choice. In another example, the processing system 200 may select different reference data for different iterations of the method 300. The different iterations of the method 300 may be performed for the same interval or for different intervals. In yet another example, the processing system 200 may select certain reference data for certain scenarios. For instance, for cases of real-time or near real-time assessment, or when Wireline logs are not available, LWD would be the first choice.

Once the mud gas log and the reference log are generated, the processing system 200 may set a depth-sampling rate of the mud gas log to a depth-sampling rate of the reference log, perhaps using interpolation. The graphical representations of the mud gas log and reference log may be referred to as a mud gas curve and a reference curve, respectively. The processing system 200 may bulk depth shift the mud gas curve based on the reference curve. For example, the processing system 200 may bulk depth shift the mud gas curve to the reference curve. In examples where the reference log is a wireline log, the processing system 200 may define the shift from an independent source, such as D-Exponent or ROP (if it correlates with reservoir porosity).

FIG. 4A illustrates an example mud gas graph 400 and FIG. 4B illustrates an example reference graph 410, according to some implementations. In this example, the mud gas graph 400 and the reference graph 410 are generated by the processing system 200 based on received drilling data. Further, the mud gas graph 400 is a normalized mud gas graph.

Returning to FIG. 3, upon completion of step 302, the processing system 200 performs data transformation step 304, which may be performed by the data acquisition module 204 or the data analysis module 206. In step 304, the processing system 200 executes a transformation algorithm to correct the mud gas log across along an interval (for example, an estimated hydrocarbon-bearing interval). Prior to executing the transformation algorithm, the processing system 200 determines whether shapes of the mud gas graph and the reference graph have a threshold level of similarity across the interval. For example, the processing system 200 determines if the graphs have a threshold number of similar features, such as shape, peaks, and troughs. If the graphs have a threshold level of similarity, then the processing system 200 proceeds with executing the transformation algorithm.

However, if the graphs do not have a threshold level of similarity, then the processing system 200 flag such zones, and determines whether the interval is to be excluded from modeling. The shapes may not be similar due to several reasons, such as: that the mud gas log is affected by severe artifacts (for example, hydrocarbons migration from drilled depth to a surface detector did not follow the assumed in time-to-depth conversion calculations, surface detector measurements errors, effects of conventional coring, hydrocarbons dispersion in the mud column), or inaccuracies in the calculated reference log.

If the processing system 200 proceeds with the transformation, the transformation algorithm reshapes the mud gas graph based on similar or matching features (for example, peaks and troughs) with the reference graph. Specifically, the reshaping is performed without reducing the total sum of the mud gas across the interval. The resulting mud gas graph shape tracks the shape of the reference graph (for example, along peaks, troughs, and bed boundaries). This justified transformation reduces depth discrepancies and accounts for oil dispersion in the mud column. Furthermore, compared to variable depth shift techniques, this transformation does not create or remove an artificial oil signal. For simplicity, the transformation algorithm is described below as a series of sub-steps. The processing system 200 may execute the sub-steps concurrently or sequentially.

In a first sub-step, the transformation algorithm detects and subtracts background noise from the mud gas log. In order to do so, the transformation algorithm defines a mud log a background noise level (NL). For example, for the mud gas graph 400, the transformation algorithm defines a background noise level that is represented by line 402. Once the noise level is defined, gas data that falls below the noise level is considered noise and is subtracted from the mud gas log.

In a second sub-step, the transformation algorithm despikes the mud gas log to remove artifacts (for example, connection gasses) that are not correlated to reservoir features. In an example, the artifacts are defined as spikes greater than a threshold that are not correlated to any reservoir features. In a third sub-step, the transformation algorithm defines the threshold (THD) as a function of the noise level. This threshold is used to determine hydrocarbon-bearing zones within the mud gas log. Here, the THD is defined as the noise level multiplied by a predetermined factor (for example, three). For example, for the mud gas curve 400, the transformation algorithm defines a threshold (THD) that is represented by dashed line 404. Additionally and/or alternatively, drilling parameters, log patterns, job knowledge or other reference logs, among other parameters, may be used to identify mud gas log features that are not representative of formation hydrocarbon response at specific depths.

In a fourth sub-step, the transformation algorithm detects potential hydrocarbon-bearing zones (ZP) in the mud gas log. In an example, the transformation algorithm may analyze the mud gas log to detect potential zones where the level of the mud log is above THD for at least NS consecutive samples. This approach eliminates false surges, such as those from connection gasses, from being treated as potential hydrocarbon-bearing intervals. This sub-step has a similar effect to a despiking filter. In the example of the mud gas curve 400, the transformation algorithm detects a potential zone 408 that has at least NS consecutive samples above the THD 404. The NS may depend on a sampling rate, which is typically 0.5-1 feet (ft), and extent of hydrocarbon zone (between 1 and 10 or even 100th of feet in a vertical well; in highly deviated and particularly horizontal wells the NS can be larger).

Once the potential hydrocarbon-bearing zones in the mud gas log have been identified, the remaining sub-steps of the transformation algorithm are executed for each ZP. For simplicity, this disclosure describes the sub-steps as executed for a single ZP. However, the sub-steps may be executed concurrently or sequentially for each detected ZP.

In a fifth sub-step, the transformation algorithm aggregates to a detected ZP any neighboring intervals that are separated by a maximum amount of sampling intervals (Nₘₐₓ) as there may be gaps or negative noise spikes that occur while the bit crosses a potentially prospective hydrocarbon-bearing interval. At the completion of this sub-step, a respective top boundary (ZPₜₒₚ) and a respective bottom boundary (ZP_{bot}) are defined for the ZP. Nₘₐₓ can be determined by the interpreter on individual case bases, similarly to NS, it can be just several feet or can be more.

In a sixth sub-step, the transformation algorithm determines a respective maximum reading (ZPₘₐₓ) for the ZP. In a seventh sub-step, the transformation algorithm computes a respective zone boundary delimiting (BD) value as a function of the respective ZPₘₐₓ and the threshold value (THD). In an example, the BD may be defined as an average value between THD and ZPₘₐₓ. For instance, the BD may be calculated as:

BD=(ZPₘₐₓ+THD)/3. Equation (1)

In FIG. 4A, for the ZP 408, the BD is represented by dashed line 406.

In an eighth sub-step, the transformation algorithm defines a respective top boundary (Bₜₒₚ) and a respective bottom boundary (B_{bot}) for the ZP. In particular, Bₜₒₚ is defined as a first depth value where the respective BD of the ZP is exceeded and B_{bot} is defined as a last depth value where the respective BD of the ZP is exceeded. For example, the Bₜₒₚ of the ZP 408 may be defined as the first depth value of the ZP 408 where the BD 406 is exceeded, and the B_{bot} is defined as the last depth value of the ZP 408 where the BD 406 is exceeded. The depth boundaries between the Bₜₒₚ and B_{bot} of the ZP are the depth boundaries of the mud gas log that are to be adjusted to the depth boundaries of a corresponding interval of the reference log.

In a ninth sub-step, a respective volume of hydrocarbons (Vₜₒₜ₁) is calculated for the interval Bₜₒₚ−B_{bot}. The volume associated with the interval Bₜₒₚ−B_{bot} is equal to the sum of the sum of the gas mud log along that interval minus contributions below the noise level (NL). This calculation is equivalent to integrating the gas mud log over the Bₜₒₚ−B_{bot} interval.

In a tenth sub-step, a respective volume of hydrocarbons (Vₜₒₜ₂) is calculated for the ZP (that is, for the interval Zₜₒₚ−Z_{bot}). The volume associated with an interval Zₜₒₚ−Z_{bot} is equal to the sum of the sum of the gas mud log along that interval minus contributions below the noise level (NL). This calculation is equivalent to integrating the gas mud log over the Zₜₒₚ−Z_{bot} interval. Vₜₒₜ₂ includes the contributions of the precursor and of the tail portion of the gas mud log, and the contributions of the main zone limited by Bₜₒₚ and B_{bot}.

In an eleventh sub-step, a ratio of Vₜₒₜ₂ to Vₜₒₜ₁ for the ZP is calculated as:

Rᵥₒₗ=Vₜₒₜ₂/Vₜₒₜ₁. Equation (2)

In a twelfth sub-step, the transformation algorithm multiplies by Rᵥₒₗ a portion of the mud gas log within the Bₜₒₚ−B_{bot} interval and above the NL. Further, the transformation algorithm removes any contribution to the mud gas log within the Zₜₒₚ−Z_{bot} interval that is located outside the Bₜₒₚ−B_{bot} interval.

In a thirteenth sub-step, the transformation algorithm performs fine tuning depth matching between the Bₜₒₚ−B_{bot} interval in the mud gas log and a corresponding interval in the reference log. The boundary corresponding to Bₜₒₚ is corrBₜₒₚ and the boundary corresponding to B_{bot} is corrB_{bot}.

In a fourteenth and final sub-step, in order to keep the total integrated volume Vₜₒₜ₂ constant, the transformation algorithm multiplies the portion of the mud gas log within the corrBₜₒₚ−corrB_{bot} interval by the ratio:

R_{dept}=(Bₜₒₚ−B_{bot})/(corrBₜₒₚ−corrB_{bot}). Equation (3)

The resultant mud gas log is the transformed mud gas log that is the output of the transformation algorithm.

Once the transformed mud gas log is generated, the processing system 200 may perform at least one of two types of analyses: a level-by-level analysis 306 and a summation analysis 308. Although the level-by-level analysis 306 precedes the summation analysis 308 in FIG. 3, these analysis can be performed in any order. In the level-by-level analysis 306, the processing system 200 compares a shape of the transformed mud gas graph with the shape of the reference graph. Based on the comparison, the processing system 200 may determine to further reshape the transformed mud gas graph. Furthermore, the analysis can derive an association or relationship between the mud gas log and the reference log, where the association or relationship can later be used to estimate a reference log (for example, a hydrocarbon fraction) from mud gas logs. In practice, there may be intervals where the reference log may not be accurate, and therefore, knowledge of common association between these logs after correcting for the artifacts can be used in the interpretation of hydrocarbon distribution.

In the summation analysis step 308, the processing system 200 may define summation intervals (for example, beds or sections of reservoir) within the transformed mud gas log and the reference log. The processing system 200 may then sum the transformed mud gas log and the reference log hydrocarbon fraction over the selected intervals. This summation creates a summed mud gas log (parts per million (ppm) per interval) and oil (v/v per interval) point log. Note that, in some examples, the summation analysis can be performed without transforming the mud gas log. That is, the summation analysis can be performed using the mud gas log and the reference log. The summation analysis can also be performed when there is high uncertainty or greater level of mismatch of mud gas graph and reference graph shapes and where the transformation algorithm cannot be run with high level of confidence. In the summation analysis, it is assumed that the total amount of hydrocarbons (summed mud gas log) are mostly affected by depth mismatches, and not by other effects, for example, produced hydrocarbons.

Upon completion of the analyses, the processing system 200 may perform a data interpretation step 310. In this step, the processing system 200 may generate a model, perhaps based on the output of the level-by-level analysis and the summation analysis, that is representative of relationship between the transformed normalized mud gas log and a hydrocarbon oil fraction. In some examples, the processing system 200 may perform the process 300 for a plurality of mud gas logs in order to refine the model of the relationship between mud gas logs and hydrocarbon fractions. In other examples, machine learning tools may be used to enhance accuracy of oil fraction estimation from the transformed mud gas logs. Furthermore, in some examples, the processing system 200 may use multivariate analysis in interpreting the data, for example, by adding mud type categorical variable.

The method 300 provides geoscientists (for example, petrophysicists, geologists, or mud logging specialists) with a tool to transform raw data based on comparison with a reference logs (for example, Wireline or Logging While Drilling surveys). The transformations are applied to match the extent of hydrocarbon column as detected by the more accurate reference logs. By transforming the data, the accuracy of hydrocarbon depth indexes and corresponding mud gas levels increase, which improves its usability for quantitative assessments. The improved data can be used to assist in petrophysical model selection, calculation of hydrocarbon in place, and planning of future wells evaluation programs (for example, in selection of mud logging equipment, drilling parameters, logging programs). Furthermore, the models generated based on the transformations may be used to determine hydrocarbon fractions, which in turn, may be used to control drilling operations.

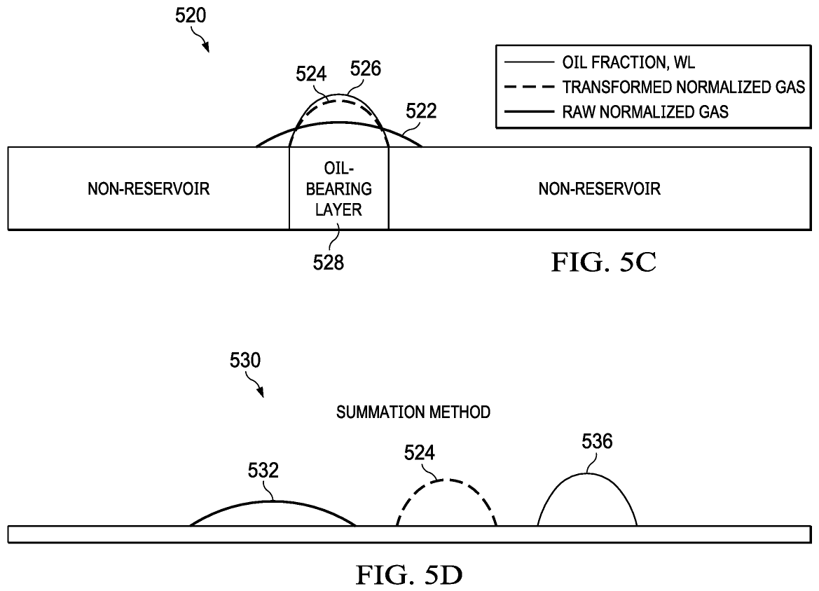

FIGS. 5A, 5B, 5C, and 5D illustrate an example of mud gas log processing, according to some implementations of the present disclosure.

FIG. 5A illustrates a normalized raw gas graph 502 generated based on mud gas data associated with an oil-bearing layer 500. FIG. 5A also illustrates an oil fraction curve 504 that is generated using wireline data. In this example, the disclosed transformation algorithm may be used to transform the normalized raw gas graph 502 to track the oil fraction graph 504. As shown in FIG. 5A, a transformed normalized gas curve 506 tracks the shape of the oil fraction curve 504.

FIG. 5B illustrates a scatter plot 510, where y-axis is reference log values and the x-axis is mud gas log values. In the scatter plot 510, data cloud 512 represents individual values for each depth comparison (for example, level-by-level) between the oil fraction log values and the transformed normalized mud gas log values. The circles 514 represent summed values of the mud gas log and summed values of the reference log for a selected thickness (or a number of samples), for example a hydrocarbon bearing bed. The data cloud 512 and the summed values represented by the circles 514 can be used to generate a model 516 that represents the relationship between mud gas logs and hydrocarbon oil fractions.

FIG. 5C is an illustration 520 of a level-by-level analysis. As shown in FIG. 5C, a raw normalized gas graph 522, a transformed mud gas graph 524, and a reference oil fraction curve 526 may be compared in the oil-bearing layer 528. FIG. 5D is an illustration 530 of a summation analysis. As shown in FIG. 5D, a total sum of gas in the normalized raw gas graph 532 is equal to the total sum of the gas in the transformed mud gas curve 534. Furthermore, the total sum of the gas in the transformed mud gas curve 534 may be compared to the total oil sum of the oil fraction curve 536.

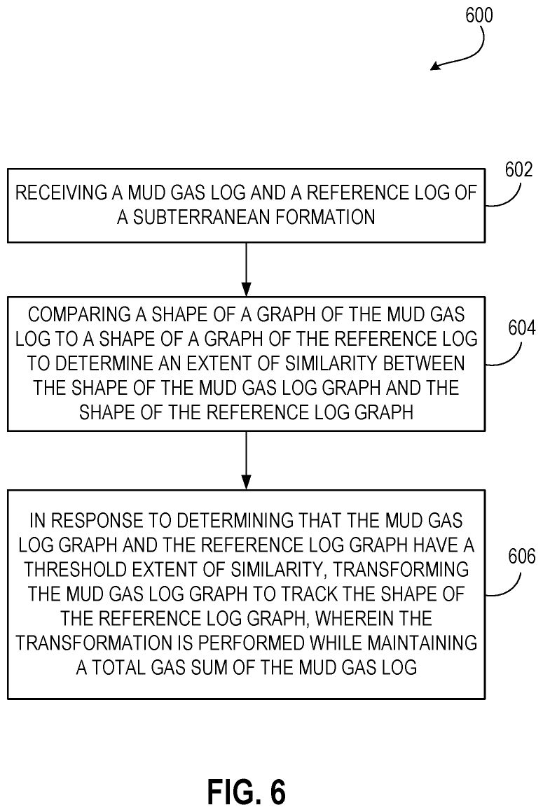

FIG. 6 is a flow chart of an example method 600 for mud gas log processing, according to some implementations. For clarity of presentation, the description that follows generally describes method 600 in the context of the other figures in this description. However, it will be understood that method 600 can be performed by any suitable system, environment, software, and hardware, or a combination of systems, environments, software, and hardware as appropriate. For example, the processing system 200 (or any system including the monitoring system 200) can be used to implement the method 600. In some implementations, various steps of method 600 can be run in parallel, in combination, in loops, or in any order.

At step 602, the method 600 involves receiving a mud gas log and a reference log of a subterranean formation. The mud gas log is a log generated based on mud gas data and the reference log is a log generated based on reference data (for example, WL or LWD data). In particular, the reference log may represent a hydrocarbon fraction in an interval of the subterranean formation. At step 604, the method involves comparing a shape of a graph of the mud gas log to a shape of a graph of the reference log to determine an extent of similarity between the shape of the mud gas log graph and the shape of the reference log graph. At step 606, the method involves determining that the mud gas log graph and the reference log graph have a threshold extent of similarity, transforming the mud gas log graph to track the shape of the reference log graph, wherein the transformation is performed while maintaining a total gas sum of the mud gas log. The total gas sum is the total amount of gas indicated in the mud gas log over a particular interval.

In some implementations, the method further includes defining a summation interval in the mud gas log and in the reference log; and summing the mud gas log and the reference log over the defined summation interval. The summation interval is an interval over which the logs are summed, where summing a log involves determining a total sum of gas or hydrocarbons indicated by the respective log over an interval.

In some implementations, the method further includes generating, based on the transformed mud gas log graph, a model of a relationship between mud gas data and hydrocarbon fractions.

In some implementations, the mud gas log is a first mud gas log, and the method further includes receiving a second mud gas log of an interval in the subterranean formation; and determining, based on the second mud gas log and the model, a hydrocarbon fraction in the interval of the subterranean formation.

In some implementations, the reference log is one of a wireline log, a logging while drilling log, or a drilling parameter log.

In some implementations, transforming the mud gas log graph to track the shape of the reference log graph includes determining, based on a predetermined hydrocarbon-bearing threshold, one or more hydrocarbon-bearing zones (ZPs) within the mud gas log graph; and reshaping the one or more hydrocarbon-bearing zones based on respective shapes of one or more portions of the reference log graph that correspond to the one or more hydrocarbon-bearing zones.

In some implementations, detecting, based on the hydrocarbon-bearing threshold, one or more hydrocarbon-bearing zones within the mud gas log graph includes detecting and subtracting background noise from the mud gas log graph, wherein the background noise is detected based on a predetermined noise level; despiking the mud gas log graph to remove artifacts that are not correlated to reservoir features; defining the hydrocarbon-bearing threshold as a function of the noise level; and identifying the one or more hydrocarbon-bearing zones by identifying values of the mud gas log graph that cross the hydrocarbon-bearing threshold.

In some implementations, reshaping the one or more hydrocarbon-bearing zones within the mud gas log graph based on respective shapes of one or more regions of the reference log graph that correspond to the one or more hydrocarbon-bearing zones includes for each hydrocarbon-bearing zone: determining a respective top boundary (ZPₜₒₚ) and a respective bottom boundary (ZP_{bot}); determining a respective maximum reading (ZPₘₐₓ); computing a respective boundary delimiting value (BD) as a function of the respective ZPₘₐₓ and the hydrocarbon-bearing threshold; determining, based on the respective BD, a respective top boundary (Bₜₒₚ) and a respective bottom boundary (B_{bot}); and fine tuning depth matching between the Bₜₒₚ−B_{bot} interval in the mud gas log graph and a corresponding interval corrBₜₒₚ−corrB_{bot} in the reference log graph.

In some implementations, fine tuning depth matching between the Bₜₒₚ−B_{bot} interval in the mud gas log graph and a corresponding interval in the reference log graph includes: calculating a respective volume of hydrocarbons (Vₜₒₜ₁) is for the interval Bₜₒₚ−B_{bot}; calculating a respective volume of hydrocarbons (Vₜₒₜ₂) for the hydrocarbon-bearing zone; calculating a ratio (Rᵥₒₗ) of Vₜₒₜ₂ to Vₜₒₜ₁; multiplying by Rᵥₒₗ a portion of the mud gas log within the Bₜₒₚ−B_{bot} interval; and fine tuning depth matching the portion of the mud gas log graph and a portion of the reference log graph within the corresponding interval.

In some implementations, the method further includes multiplying the fine tune depth matched portion of the mud gas log graph by a ratio of the Bₜₒₚ−B_{bot} interval to the corrBₜₒₚ−corrB_{bot} interval.

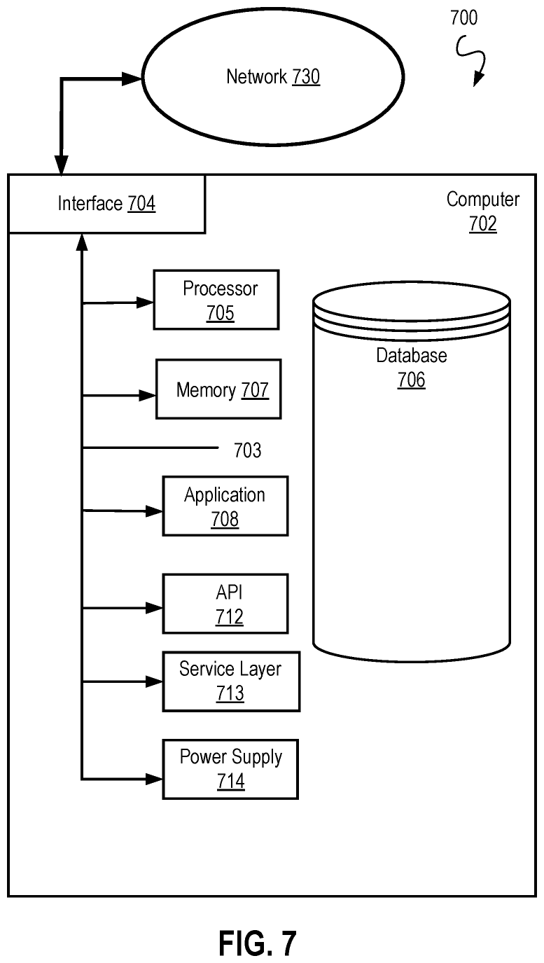

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as standalone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/nonvolatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
receiving a mud gas log and a reference log of a subterranean formation;
comparing a shape of a graph of the mud gas log to a shape of a graph of the reference log to determine an extent of similarity between the shape of the mud gas log graph and the shape of the reference log graph; and
in response to determining that the mud gas log graph and the reference log graph have a threshold extent of similarity, transforming the mud gas log graph to track the shape of the reference log graph, wherein the transformation is performed while maintaining a total gas sum of the mud gas log.

2. The method of claim 1, further comprising:
defining a summation interval in the mud gas log and in the reference log; and
summing the mud gas log and the reference log over the defined summation interval.

3. The method of claim 1, further comprising:
generating, based on the transformed mud gas log graph, a model of a relationship between mud gas data and hydrocarbon fractions.

4. The method of claim 3, wherein the mud gas log is a first mud gas log, and the method further comprising:
receiving a second mud gas log of an interval in the subterranean formation; and
determining, based on the second mud gas log and the model, a hydrocarbon fraction in the interval of the subterranean formation.

5. The method of claim 1, wherein the reference log is one of a wireline log, a logging while drilling log, or a drilling parameter log.

6. The method of claim 1, wherein transforming the mud gas log graph to track the shape of the reference log graph comprises:
determining, based on a predetermined hydrocarbon-bearing threshold, one or more hydrocarbon-bearing zones (ZPs) within the mud gas log graph; and
reshaping the one or more hydrocarbon-bearing zones based on respective shapes of one or more portions of the reference log graph that correspond to the one or more hydrocarbon-bearing zones.

7. The method of claim 6, detecting, based on the hydrocarbon-bearing threshold, one or more hydrocarbon-bearing zones within the mud gas log graph comprises:
detecting and subtracting background noise from the mud gas log graph, wherein the background noise is detected based on a predetermined noise level;
despiking the mud gas log graph to remove artifacts that are not correlated to reservoir features;
defining the hydrocarbon-bearing threshold as a function of the noise level; and
identifying the one or more hydrocarbon-bearing zones by identifying values of the mud gas log graph that cross the hydrocarbon-bearing threshold.

8. The method of claim 6, wherein reshaping the one or more hydrocarbon-bearing zones within the mud gas log graph based on respective shapes of one or more regions of the reference log graph that correspond to the one or more hydrocarbon-bearing zones comprises:
for each hydrocarbon-bearing zone:
determining a respective top boundary (ZPₜₒₚ) and a respective bottom boundary (ZP_{bot});
determining a respective maximum reading (ZPₘₐₓ);
computing a respective boundary delimiting value (BD) as a function of the respective ZPₘₐₓ and the hydrocarbon-bearing threshold;
determining, based on the respective BD, a respective top boundary (Bₜₒₚ) and a respective bottom boundary (B_{bot}); and
fine tuning depth matching between the Bₜₒₚ−B_{bot} interval in the mud gas log graph and a corresponding interval corrBₜₒₚ−corrB_{bot} in the reference log graph.

9. The method of claim 8, wherein fine tuning depth matching between the Bₜₒₚ−B_{bot} interval in the mud gas log graph and a corresponding interval in the reference log graph comprises:
calculating a respective volume of hydrocarbons (Vₜₒₜ₁) is for the interval Bₜₒₚ−B_{bot};
calculating a respective volume of hydrocarbons (Vₜₒₜ₂) for the hydrocarbon-bearing zone;
calculating a ratio (Rᵥₒₗ) of Vₜₒₜ₂ to Vₜₒₜ₁;
multiplying by Rᵥₒₗ a portion of the mud gas log within the Bₜₒₚ−B_{bot} interval; and
fine tuning depth matching the portion of the mud gas log graph and a portion of the reference log graph within the corresponding interval.

10. The method of claim 9, further comprising:
multiplying the fine tune depth matched portion of the mud gas log by a ratio of the Bₜₒₚ−B_{bot} interval to the corrBₜₒₚ−corrB_{bot} interval.

11. A non-transitory, computer-readable medium storing one or more instructions executable by a computer system to perform operations comprising:
receiving a mud gas log and a reference log of a subterranean formation;
comparing a shape of a graph of the mud gas log to a shape of a graph of the reference log to determine an extent of similarity between the shape of the mud gas log graph and the shape of the reference log graph; and
in response to determining that the mud gas log graph and the reference log graph have a threshold extent of similarity, transforming the mud gas log graph to track the shape of the reference log graph, wherein the transformation is performed while maintaining a total gas sum of the mud gas log.

12. The non-transitory, computer-readable medium of claim 11, the operations further comprising:
defining a summation interval in the mud gas log and in the reference log; and
summing the mud gas log and the reference log over the defined summation interval.

13. The non-transitory, computer-readable medium of claim 11, the operations further comprising:
generating, based on the transformed mud gas log graph, a model of a relationship between mud gas data and hydrocarbon fractions.

14. The non-transitory, computer-readable medium of claim 13, wherein the mud gas log is a first mud gas log, and the operations further comprising:
receiving a second mud gas log of an interval in the subterranean formation; and
determining, based on the second mud gas log and the model, a hydrocarbon fraction in the interval of the subterranean formation.

15. The non-transitory, computer-readable medium of claim 11, wherein transforming the mud gas log graph to track the shape of the reference log graph comprises:
determining, based on a predetermined hydrocarbon-bearing threshold, one or more hydrocarbon-bearing zones (ZPs) within the mud gas log graph; and
reshaping the one or more hydrocarbon-bearing zones based on respective shapes of one or more portions of the reference log graph that correspond to the one or more hydrocarbon-bearing zones.

16. The non-transitory, computer-readable medium of claim 15, detecting, based on the hydrocarbon-bearing threshold, one or more hydrocarbon-bearing zones within the mud gas log graph comprises:
detecting and subtracting background noise from the mud gas log graph, wherein the background noise is detected based on a predetermined noise level;
despiking the mud gas log graph to remove artifacts that are not correlated to reservoir features;
defining the hydrocarbon-bearing threshold as a function of the noise level; and
identifying the one or more hydrocarbon-bearing zones by identifying values of the mud gas log graph that cross the hydrocarbon-bearing threshold.

17. The non-transitory, computer-readable medium of claim 15, wherein reshaping the one or more hydrocarbon-bearing zones within the mud gas log graph based on respective shapes of one or more regions of the reference log graph that correspond to the one or more hydrocarbon-bearing zones comprises:
for each hydrocarbon-bearing zone:
determining a respective top boundary (ZPₜₒₚ) and a respective bottom boundary (ZP_{bot});
determining a respective maximum reading (ZPₘₐₓ);
computing a respective boundary delimiting value (BD) as a function of the respective ZPₘₐₓ and the hydrocarbon-bearing threshold;
determining, based on the respective BD, a respective top boundary (Bₜₒₚ) and a respective bottom boundary (B_{bot}); and
fine tuning depth matching between the Bₜₒₚ−B_{bot} interval in the mud gas log graph and a corresponding interval corrBₜₒₚ−corrB_{bot} in the reference log graph.

18. The non-transitory, computer-readable medium of claim 17, wherein fine tuning depth matching between the Bₜₒₚ−B_{bot} interval in the mud gas log graph and a corresponding interval in the reference log graph comprises:
calculating a respective volume of hydrocarbons (Vₜₒₜ₁) is for the interval Bₜₒₚ−B_{bot};
calculating a respective volume of hydrocarbons (Vₜₒₜ₂) for the hydrocarbon-bearing zone;
calculating a ratio (Rᵥₒₗ) of Vₜₒₜ₂ to Vₜₒₜ₁;
multiplying by Rᵥₒₗ a portion of the mud gas log within the Bₜₒₚ−B_{bot} interval; and
fine tuning depth matching the portion of the mud gas log graph and a portion of the reference log graph within the corresponding interval.

19. The non-transitory, computer-readable medium of claim 18, the operations further comprising:
multiplying the fine tune depth matched portion of the mud gas log graph by a ratio of the Btop−Bbot interval to the corrBtop−corrBbot interval.

20. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving a mud gas log and a reference log of a subterranean formation;
comparing a shape of a graph of the mud gas log to a shape of a graph of the reference log to determine an extent of similarity between the shape of the mud gas log graph and the shape of the reference log graph; and
in response to determining that the mud gas log graph and the reference log graph have a threshold extent of similarity, transforming the mud gas log graph to track the shape of the reference log graph, wherein the transformation is performed while maintaining a total gas sum of the mud gas log.
